(19) United States
(12) Patent Application Publication
(10) Pub. No.: US 2010/0024781 A1
(43) Pub. Date: Feb. 4, 2010

(54) Compressed Fuel Supply System

(76) Inventor: Jerry Wegendt, Boone, NC (US)

Correspondence Address: Jerry Wegendt, 250 ThornTree Drive, Boone, NC, 28607, US

(21) Appl. No.: 12/346,444

(22) Filed: Dec. 30, 2008

Related U.S. Application Data
(60) Provisional application No. 61/084,976, filed on Jul. 30, 2008.

(51) Int. Cl. F02M 33/02

(52) U.S. Cl. 123/518

(57) ABSTRACT

The compressed fuel supply system is a simple low cost fuel fumes delivery system that will replace the present day liquid fuel delivery system used on the present day internal combustion engines. The system will deliver a constant supply of fuel fumes for all ranges of required engine performance. This invention is designed for the standard modern internal combustion engine (5). Equipped with such standard equipment as fuel injectors (4), oxygen sensor/control unit (7) installed in the engine exhaust manifold. An air inlet control valve (6) located on the engine inlet manifold.

### PRIOR FILING

This application emanates from a previously filed application No. 61/084,976 filed Jul. 30, 2008

### FIELD OF THE INVENTION

This invention relates to the use of high pressure fuel fumes to power an engine and, more particularly, to make improvements that enhance fuel efficiency with a clean burn that reduces exhaust pollutions

The conventional liquid fuel supply system for the internal combustion engine is replaced by a high pressure compressed fuel fume system. The system adds high pressure ambient air to the bottom of a high pressure fuel vessel, defuses the hydrogen from the liquid producing rich hydrogen fumes.

The high pressure fumes are stored in the pressure vessel then fed to the engine by the operator for the engine performance desired. The fumes are injected directly into the piston cavity using the engine fuel injectors.

The mixture is controlled at 1 to 30 fuel to air by the O2 sensor/control unit using the inlet air control valve located on the engine intake manifold.

The system uses temperature and pressure controls for the fuel fumes to insure max engine performance.

This is a simple low cost fuel fumes delivery system that will replace the present day liquid fuel delivery system used on the present day internal combustion engines.

The system will deliver a constant supply of fuel fumes for all ranges of required engine performance.

### BACKGROUND OF THE INVENTION

Since 1914 it has been known that you could operate a gasoline engine on fuel fumes. The problem has been how to deliver the fuel fumes to the engine. There have been many devices patented but at present there is no production engine using a high pressure fuel fume delivery system as the fuel delivery system for the internal combustion engine.

All present day Engines burn liquid fuel and suck the fuel vapor using the engine vacuum system to remove the fuel vapors produced in the liquid storage tank This is only to stop the fumes from entering the atmosphere as pollutants, not for fuel a delivery system for the engine.

### PRIOR PATENTS

The following patents have been reviewed. None of the following patents in any way use this unique delivery system of high pressure compressed fuel fumes directly into the engine piston cavity using a fuel injector system.

| Pat. No. | Name | Date |
|---|---|---|
| 7,380,546 | Bushnell | Jun. 03, 2008 |
| 4,338,907 | Lindbeck | Jul. 13, 1982 |
| 4,335,697 | McLean | Jun. 22, 1982 |
| 5,540,208 | Kikuiani | Jun. 30, 1996 |
| 4,249,502 | Hover | Feb. 10, 1981 |
| 3,713,429 | Dwyre | Jan. 03, 1973 |
| 6,966,308 | Bushnall | Nov. 22, 2005 |
| 4,955,351 | Lewis | Sep. 11, 1990 |
| 6,681,749 | Bushnell | Jan. 27, 2004 |

### SUMMARY OF THE INVENTION

This system will replace the present day liquid fuel delivery system for the gasoline engine.

The high pressure fuel fume system will completely replace the liquid fuel delivery system and maintain a desired ratio of 1 to 30 fuel to air ratio which is the most efficient burn ratio.

There is at present no system that uses this technology of high pressure fuel fumes for a fuel delivery system for gasoline engines. The proposed system will increase the fuel mileage per gallon with a reduction pollution level in the atmosphere.

High pressure fumes are injected directly into the piston cavity in the engine block area. The present day systems use liquid fuel and the engine vacuum to draw the fumes produced in the liquid fuel tank from entering the atmosphere as pollution.

This system adds air to the storage tank by bubbling the replacement air thru the liquid fuel releasing the hydrogen atoms producing fuel fumes similar to propane gas (C3H8).

However, it does not have the handling or safety problems associated with handling liquid natural gas or the safety concerns.

A heater element and thermostat located on the bottom of the liquid storage tank will ensure the fumes are at the desired temperature for out gassing.

The fuel fumes are then compressed producing the same (BTU) energy as the propane gas mixture (C3H8), in turn the fumes are stored in the high pressure storage vessel for use by the engine operator.

The fumes are then fed into the engine by the operator using a throttle device for the desired engine performance and fed directly into the engine piston cavity area using the engine injector system

The O2 Sensor located in the exhaust manifold in the present day vehicles is capable of controlling the air mixture using the air control valve located on the Engine air inlet manifold to maintain the most efficient fuel air ratio of 1 to 30 by monitoring the hydrocarbons in the exhaust system.

The liquid fuel storage tank will have a safety lock cap for pressure relief prior to refueling and a drain sump located on the bottom of the tank for draining of residual material from the tank.

There will be no afterburning in the engine cylinders during the ignition process that reduces the efficiency of the present day liquid supply system. This new system will reduce wear and tear on the engine by eliminating the liquid fuel that is not consumed during ignition from entering the crankcase of the engine.

The principle purpose of this device is to provide a relatively simple but efficient fuel fume supply system for an internal combustion engine.

This is a unique system using high pressure fuel fumes in place of the standard liquid fuel systems used on the present day gasoline engines. This is a novel approach as it uses high pressure fuel fumes produced and stored in the Fuel storage vessel (2) that is in addition the liquid fuel storage tank.

The present day liquid storage tank is replaced with a high pressure Fuel storage vessel (2) with inlet and outlet fittings and a fill neck to add the liquid fuel to the storage tank. The fuel fumes are stored on top of the liquid fuel.

This method of a fuel fume delivery system will reduce the unburned hydrocarbons and oxides which are undesirable atmospheric pollutants helping to reduce the pollutants in our atmosphere.

To my best of my knowledge this system at present is not commercially available. This system is economical to fabricate and install in all modern motor vehicles replacing the present liquid fuel supply system now being used,

Numerous devices have been proposed to improve the efficiency of the present day gasoline engine by using the engine vacuum system to remove fuel fumes from the liquid fuel storage tank from entering the atmosphere. To the best of my knowledge, there is no system in operation or proposed that uses a high pressure compressed fuel fume supply system that improves gas mileage and reduces pollutants in the atmosphere.

### BRIEF DESCRIPTION OF THE ILLUSTRATION

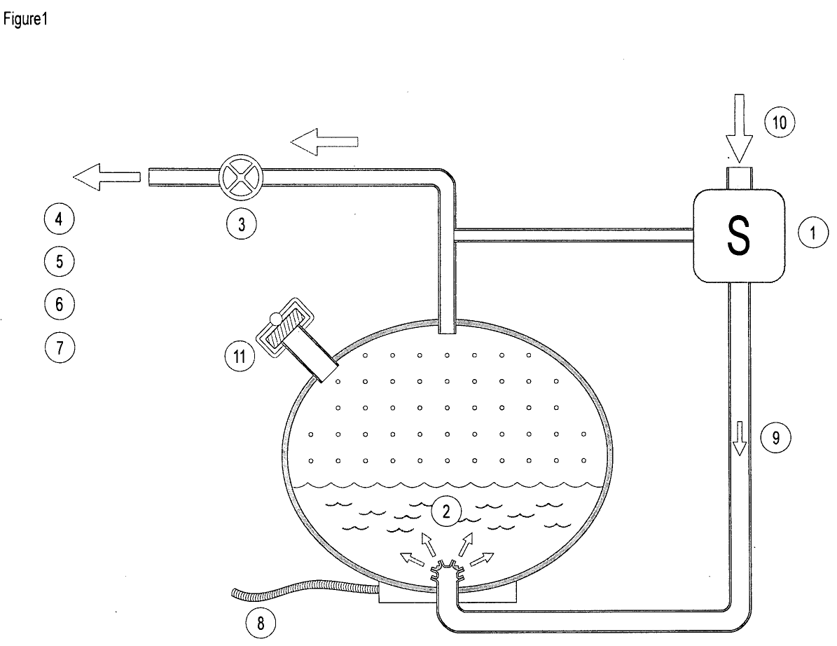

FIG. 1 is the frontal view of the device depicting;
1. Fuel tank air compressor (1) and pressure switch for liquid tank replacement air for the fuel storage vessel (2). This replacement air is supplied into the bottom of the vessel and under pressure is bubbled through the liquid fuel to release the fuel fumes. The fuel fumes are in turn stored in the top of the fuel storage vessel (2) The pressure switch ensures that the fuel fumes are maintained at the desired operating pressure
2. Fuel storage vessel (2) with pressure relief valve is a combination vessel for storage of liquid fuel and high pressure fuel vapors to be supplied to engine by the throttle control valve (3) controlled by the engine operator. The pressure vessel must meet the OSHA requirements of OSHA 29 CFR 1910.
3. Fuel fumes throttle control (3) used by the engine operator to supply the fuel fumes to the engine injectors (4) for the desired engine performance
4. Engine fuel injectors (4), for proper injection of the fuel fumes into the piston block cavity using the standard engine timing on the engine assembly
5. Engine assembly (5) a standard internal combustion gasoline engine.
6. Engine air inlet control valve (6) this unit works in conjunction with the engine oxygen control sensor and control (7) unit to maintain the proper air ratio of 1 to 30 fuel to air ratio.
7. Oxygen sensor/control unit (7) this device controls the air control valve (6) ensuring a burn ratio of 1 to 30 fuel to air ratio for the best engine performance.
8. Heating element and thermostat (8) for fuel storage vessel (2) this device maintains the liquid fuel at the desired temperature for out gassing of the fuel fumes.
9. Interconnecting plumbing (conduits) (9) for routing the fuel fumes and replacement air from the compressor (1) to the fuel storage vessel (2). Routing the fumes to the throttle control (3) then to the engine fuel injectors (4) a check valve is installed in the system to prevent reverse liquid flow from the fuel storage vessel (2) to the Fuel tank air compressor. (1)
10. Ambient Air (10)
11. Liquid fuel fill cap with relief valve (11) this will ensure the fuel tank vents to zero pressure prior to removing the liquid fill fuel cap for safety of the operator.

### DETAILED DESCRIPTION OF THE PREFERRED EMBODIMENTS

The present invention will now be described more fully hereinafter with references to the accompanying drawings, in which preferred embodiments of the invention are shown. This invention may, however, be embodied in many different forms and should not be constructed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

This invention is designed for the standard modern internal combustion engine (5). Equipped with such standard equipment as fuel injectors (4), oxygen sensor/control unit (7) installed in the engine exhaust manifold. An air inlet control valve (6) located on the engine inlet manifold.

The balances of the components are used to achieve the objectives of this Invention.

This system takes ambient inlet air (10) which is drawn into the compressor (1) which compresses the air and it is fed into the interconnecting plumbing/conduits (9) to the Fuel storage vessel (2). The compressor has a feedback line to maintain the required pressure in the fuel storage vessel (2). A check valve is installed in the interconnecting plumbing/conduits (9) to ensure no reversed flow of liquid or fuel fumes.

The air enters the bottom the fuel storage vessel (2) and is defused and bubbled thru the liquid in the gasoline releasing the hydrogen fumes.

The high pressure fuel fumes are then stored over the liquid in the fuel storage vessel (2) for future use by the engine operator.

This is a combination liquid and high pressure fuel storage vessel (2) is designed to meet all the high pressure requirements Per OSHA 29 CFR 1910, with a fuel drain peacock to the drain the residual material not used in the out gassing process.

As liquid fuel is required it will be added using the fill cap (11) which is equipped with a safety relief valve.

In addition the fuel storage vessel (2) it is equipped with a heating element and thermostat (8) located on the bottom of the fuel storage vessel (2) to ensure the liquid fuel is at the proper temperature for out gassing.

The engine operator will use the fuel fumes throttle control (3) to achieve the desired engine performance releasing the high pressure fuel fumes from the fuel storage vessel (2).

The fumes will be then fed into the engine fuel injectors (4) by the interconnecting plumbing/conduits (9) The fumes are injected directly into the piston cavity by the engine fuel injectors (4) located in the engine assembly (5).

The oxygen sensor/control unit (7) located in the engine assembly (5) Exhaust manifold will monitor the hydrocarbon output of the engine assembly (5). The oxygen sensor/control unit (7) will make any adjustments required by controlling the engine air inlet control valve (6) to maintain a fuel air ratio of 1 to 30 which is most efficient burn ratio.

This invention will produce a constant supply of high pressure fuel fumes for the internal combustion engine

The vapors are produced from liquid gasoline by pumping high pressure ambient air through the liquid gasoline and storing the vapors for future needs.

This system enhances the fuel mileage and greatly reduces the pollution problem with the use of liquid gasoline in the internal combustion engine.

This system will reduce afterburning, and reduces carbon build up, Engine wear and sludge deposits in the engine crankcase.

What is claimed:

1. A high pressure compressed Fuel Fume System comprising;
A. Fuel tank air compressor (1) and pressure switch;
B. Fuel storage vessel (2) with pressure relief valve is a combination vessel for storage of liquid fuel and high pressure fuel vapors;
C. Fuel fumes throttle control; (3)
D. Engine Assembly internal combustion (5)
E. Engine fuel injectors (4)
F. Engine air inlet control valve (6)
G. Oxygen sensor/control unit (7)
H. Heating element and thermostat; (8)
I. Interconnecting plumbing (conduits) (9) for fuel fume transfer) and check valve.

2. A compressed fuel fume system as described in claim 1, wherein the replacement air is supplied under high pressure into the bottom of the Fuel storage vessel (2) and is bubbled through the liquid fuel releasing the fuel fumes.

3. A compressed fuel fume system as described in claim 1, wherein high pressure fuel vapors are supplied to the engine by the throttle control valve (3) controlled by the engine operator.

4. A compressed fuel fume system as described in claim 1, wherein the engine oxygen sensor/control (7) unit maintain the proper air ratio of 1 to 30 fuel to air ratio.
